(19) United States
(12) Patent Application Publication
(10) Pub. No.: US 2011/0113285 A1
(43) Pub. Date: May 12, 2011

(54) SYSTEM AND METHOD FOR DEBUGGING MEMORY CONSISTENCY MODELS

(75) Inventors: JULIAN DOLBY, Hawthorne, NY (US); Emina Torlak, Yorktown Heights, NY (US); Mandana Vaziri, Yorktown Heights, NY (US)

(73) Assignee: INTERNATIONALS BUSINESS MACHINES CORPORATION, Armonk, NY (US)

(21) Appl. No.: 12/615,657

(22) Filed: Nov. 10, 2009

(51) Int. Cl. G06F 11/07

(52) U.S. Cl. 714/28; 714/45; 714/E11.029

(57) ABSTRACT

A system and method for analyzing a test program with respect to a memory model includes preprocessing a test program into an intermediate form and translating the intermediate form of the test program into a relational logic representation. The relational logic representation is combined with a memory model to produce a legality formula. A set of bounds are computed on a space to be searched for the memory model or on a core of the legality formula. A relational satisfiability problem is solved, which is defined by the legality formula and the set of bounds to determine a legal trace of the test program or debug the memory model.

### BACKGROUND

1. Technical Field

The present invention relates to program analysis and more particularly to system and methods for analyzing memory models.

2. Description of the Related Art

In a multi-threaded shared memory system, a memory consistency model or a memory model is a contract between a programmer and a programming environment. The memory model specifies the behavior of accesses to shared locations, and specifically, the values observed by each read access. There is a vast amount of work on models at a hardware interface, and more recently, at a programming language level. The most intuitive memory model is a sequential consistency model, which is similar to the behavior of memory in a sequential setting. This requires that all accesses appear to execute one at a time, respecting the program order of each thread. This simplicity comes at a price: sequential consistency disallows many compiler and hardware optimizations that reorder instructions, because it enforces a strict order among accesses. Many relaxed memory models have been proposed that ease these restrictions, striking a balance between ease-of-programming and allowing compiler and hardware optimizations. However, the added complexity makes relaxed memory models difficult to reason about.

### SUMMARY

A system and method for analyzing a test program with respect to a memory model includes preprocessing a test program into an intermediate form and translating the intermediate form of the test program into a relational logic representation. The relational logic representation is combined with a memory model to produce a legality formula. A set of bounds are computed on a space to be searched for the memory model or on a core of the legality formula. A relational satisfiability problem is solved, which is defined by the legality formula and the set of bounds to determine a legal trace of the test program or debug the memory model.

A system for analyzing a test program with respect to a memory model includes a processor configured to execute and analyze programs stored in memory. The processor receives as input a test program converted to an intermediate form and a memory model. A translation module is stored in memory and executed using the processor. The translation module is configured to translate the intermediate form of the test program into a relational logic representation of the test program using a translation function. A constraint assembler, stored in memory and executed using the processor, is configured to combine the relational logic representation with the memory model to produce a legality formula. A bound assembler, stored in memory and executed using the processor, is configured to compute a set of bounds on a space to be searched for the memory model or a core of the legality formula. A solver is configured to solve a relational satisfiability problem defined by the legality formula and the set of bounds to at least one of determine a legal trace of the test program and debug the memory model.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for analyzing and debugging memory models in accordance with one illustrative embodiment;

FIG. 2A is a schematic notation of a sample test program for testing memory consistency models;

FIG. 2B is an annotated Java encoding of the sample test program for testing memory consistency models of FIG. 2A;

FIG. 3 is a listing of sequential consistency formulas in relational logic;

FIG. 4 is a listing of revised Java Memory Model (JMM) relational logic formulas;

FIG. 5 is a witness showing that the test program of FIG. 2 has a legal execution under the revised JMM of FIG. 4;

FIG. 6 is a minimal core of constraints for a problem F(P,M) where P is the program of FIG. 2 and M is a sequential consistency model in FIG. 3;

FIG. 7 is a block diagram showing a system for analyzing and debugging memory models in accordance with one illustrative embodiment;

FIG. 8 is a listing of relational logic operators;

FIG. 9 is a code listing of an annotated Java encoding along with a graph showing an intermediate representation of the program P in accordance with the present principles;

FIG. 10 shows syntax for statements in the intermediate representation of FIG. 9;

FIG. 11 shows a translation function T employed to translate the intermediate representation to relational logic in accordance with the present principles;

FIG. 12A shows partial functions L, V and G;

FIG. 12B shows a relational representation R(P)=(|I(P), L, V, G|);

FIG. 13 shows a constraint assembly function F in accordance with the present principles;

FIG. 14 shows a listing of functions employed by the tool for computing a universe and bounds in accordance with the present principles;

FIG. 15 shows a COMPUTE-ACTS procedure for computing an assignment of actions to statements in accordance with the present principles; and

FIG. 16 is an acts mapping for the program shown in FIG. 9 along with upper bounds.

### DETAILED DESCRIPTION OF PREFERRED EMBODIMENTS

Memory models are difficult to reason about due to their complexity. Memory models need to strike a balance between ease-of-programming and allowing compiler and hardware optimizations. An automated tool in accordance with the present principles helps in debugging and reasoning about memory models. The tool takes as input a memory model described axiomatically by a set of constraints, as well as a multi-threaded test program containing assertions, and outputs a trace of the program for which the assertions are satisfied, if one can be found. The tool is fully automatic, requiring no guidance from the user and is based on a satisfiability (e.g., SAT) solver.

If the tool cannot find a trace, it outputs a minimal subset of the constraints that are unsatisfiable. This feature helps the user in debugging the memory model because it shows which constraints cause the test program to have no executions that satisfy all of its assertions.

The present principles provide an extensible framework for defining memory models in an axiomatic style, a tool that takes a test program with assertions and a memory model as input, and finds a trace satisfying the assertions, if one can be found. Otherwise, the tool outputs an unsatisfiable core, which shows which constraints prevent the assertions from being satisfied.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

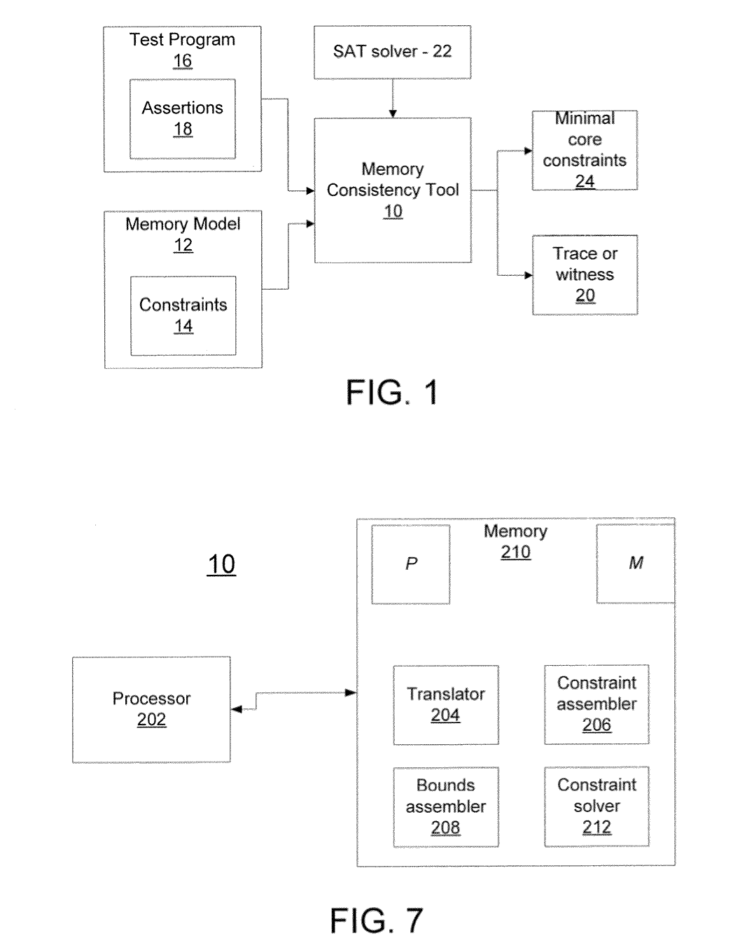

Referring now to the drawings in which like numerals represent the same or similar elements and initially to FIG. 1, an automated memory consistency tool 10 debugs and reasons about memory models. The tool 10 takes as input a memory model 12 described by a set of constraints 14, as well as a multi-threaded test program 16 containing assertions 18, and outputs a trace 20 of the program 16 for which the assertions are satisfied, if one can be found. The role of assertions 18 is to express whether the computation of a given value at a given program point is permitted according to the memory model 12 under consideration. The tool 10 is fully automatic, requiring no guidance from a user, and is based on a SAT solver 22. The test program 16 is translated into constraints that are assembled with the constraints describing the memory model 12. If the combined result is satisfiable according to the SAT solver 22, then a satisfying trace or a witness has been found. Otherwise, the tool 10 outputs a minimal subset 24 of the constraints that are unsatisfiable, called an unsatisfiable core. The unsatisfiable core can help the user in debugging the memory model 12 because it shows which constraints prevent the assertions 18 in the test program from being satisfied.

If the test program contains no loops, the result of tool 10 is sound and complete, meaning that there are no spurious witnesses, and if a witness exists, it is found. If the tool 10 uses an under-approximation, it may miss witnesses, so it is sound but not complete. In practice, however, we have found that most tests for memory models 12 do not contain loops.

Our case studies indicate that the tool 10 can be used to quickly and easily run multi-threaded test cases against different memory models. Previous approaches to checking memory models include theorem proving, model checking, constraint solving, and logic programming. Unlike most techniques, the present tool 10 is not bound to a specific memory model. We have a well-defined interface for specifying a new model, and supporting any memory model that can be defined in terms of constraints over a few simple relations. The present approach is different from previous frameworks in that se support an axiomatic-style of specification, and the tool 10 can handle current model versions.

The present approach permits rapid prototyping of memory models: the user can quickly see the effect of changes on the tests, and the unsatisfiable core helps to identify what constraints, if any, need to be changed to obtain the desired behavior. The tool 10 is designed as an extensible framework for specifying, testing and debugging memory models 12.

The tool 10 takes as inputs the multi-threaded test program 16 with one or more assertions 18; a specification of a memory model 12 in relational logic; and a set of code finitization parameters, such as the number of times to unwind loops and the length of bitvectors used to represent integers. The test program 16 is then finitized (by unwinding loops, inlining method calls, and replacing integers with bitvectors) and translated to relational logic. The resulting constraints are combined with the memory model constraints and handed off to a SAT-based constraint solver 22. If the combined constraints are satisfiable, the program 16 is said to be legal with respect to the memory model 12, and the output of the tool 10 is a concrete witness of legality, expressed in terms of the relations defined by the memory model 12. Otherwise, the program 16 is said to be illegal, and the output is a proof of illegality, expressed as a minimal unsatisfiable core of the combined constraints.

Test program (16): A test program consists of an (implicit) initialization thread and two or more user threads. The initialization thread executes first, writing default values to all shared memory locations referenced in the program. The user threads execute after the initialization has completed, running either in parallel or in a partial order specified by the user. Programs are encoded in a subset of Java™ that includes control flow constructs, the synchronized construct (which generates lock and unlock instructions on a given monitor), method calls, field and array accesses, integer and boolean operations, and assertions.

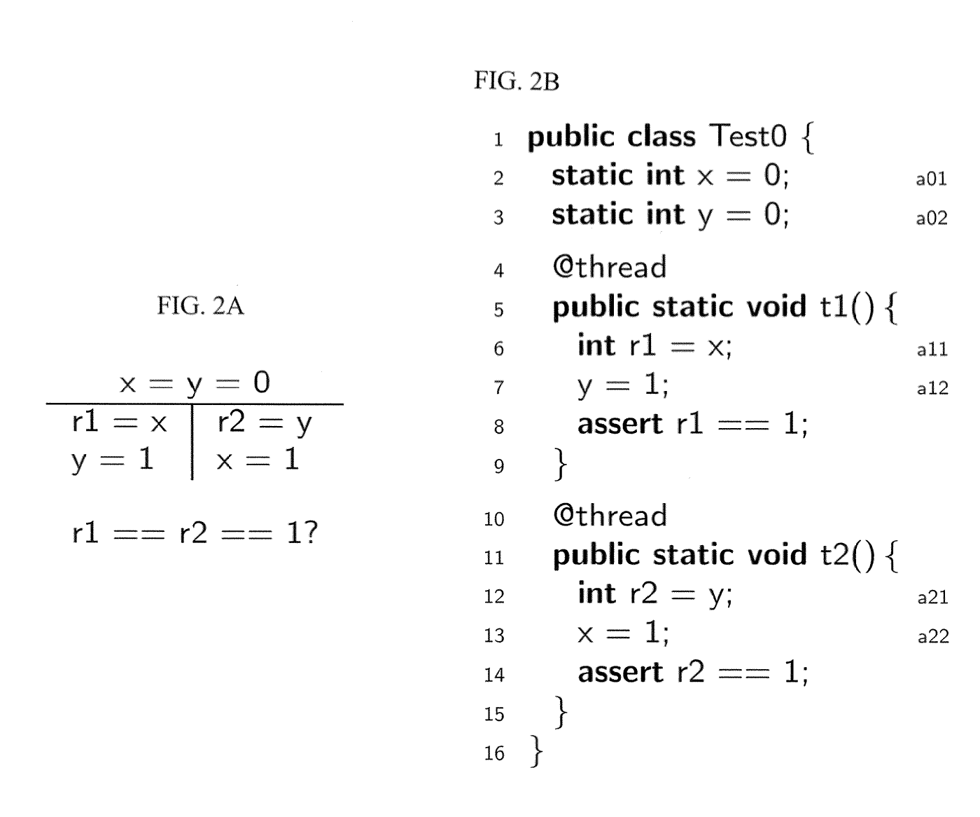

Referring to FIGS. 2A and 2B, a test program from Manson et al. (“The Java Memory Model”, POPL '05, pages 378-391, 2005) both in a standard schematic notation (FIG. 2A) and as an annotated Java program (FIG. 2B) accepted by the tool 10 (FIG. 1). The program consists of three threads each: an initialization thread that writes default values to shared memory locations, and two user threads that execute in parallel. In the schematic notation (FIG. 2A), threads that run in parallel are separated by a vertical bar; threads whose execution is partially ordered are separated by horizontal bars. In the Java encoding (FIG. 2B), the implicit static initialization method holds the code for the initialization thread, while the methods annotated with “@thread” hold the code for user threads. In both encodings, variables x and y refer to shared memory locations, and r1 and r2 refer to thread-local registers.

Memory model specification: When a test program is executed, it performs a finite set of memory-related operations or actions. An action belongs to one thread and has one of the following action kinds: thread start, thread end, volatile read, volatile write, normal read, normal write, lock, unlock, and special action. Read, write, lock and unlock actions are generated by executing read, write and synchronize instructions. Thread start and end actions mark the beginning and termination of a thread and do not correspond to any instructions. Special actions are generated by calls to methods that are designated as “special” in the definition of a given memory model. The Java Memory Model (JMM), for example, designates all I/O methods as special, and calls to these methods affect ordering of memory operations.

The kind of an action and the thread to which it belongs are static properties that the tool 10 infers from the program text. In our framework, these properties are given as relational constants; that is, constants whose meaning is a set of tuples. For example, the relative ordering of actions within a program's control flow graph is modeled by the binary relation co. The value of co for the program in FIG. 2 is the set {<s0, a01>, <a01, a02>, <a02, e0>, <s1, a11>, <a11, a12>, <a12, e1>, <s0, a21>, <a21, a22>, <a22, e2>}, where aij represents the action generated by the j^{th} instruction of the i^{th} thread, and si and ei represent the start and end actions of the i^{th} thread. The tool 10 populates relational constants automatically and provides them to the user as basic blocks for specifying constraints about memory models.

Runtime properties of a program are given as a set of relational variables which collectively define an execution of that program. An execution is a structure E=(|A, W, V, l, m, Oₙ, . . . , O_{f}|) in which A denotes the subset of the program's actions that are executed; the write-seen relation W maps each executed read to the write whose value is seen by that read; the value-written relation V maps each write action to the value that is written; the location-accessed relation I maps each read and write to the memory location that it accesses; and the monitor-used relation m maps each lock and unlock to its associated monitor. The definition of an execution may also include any number of ordering relations Oᵢ over A (e.g. happens-before relations) that are specific to a given memory model.

A memory model is specified as a set of constraints over the relational constants that describe a program and the relational variables that describe an execution. The constraints are given in relational logic, that is, first order logic with quantifiers, relations, and transitive closure. One feature of the logic is that it does not distinguish between scalars, sets and relations. In particular, sets are treated as unary relations and scalars as singleton unary relations.

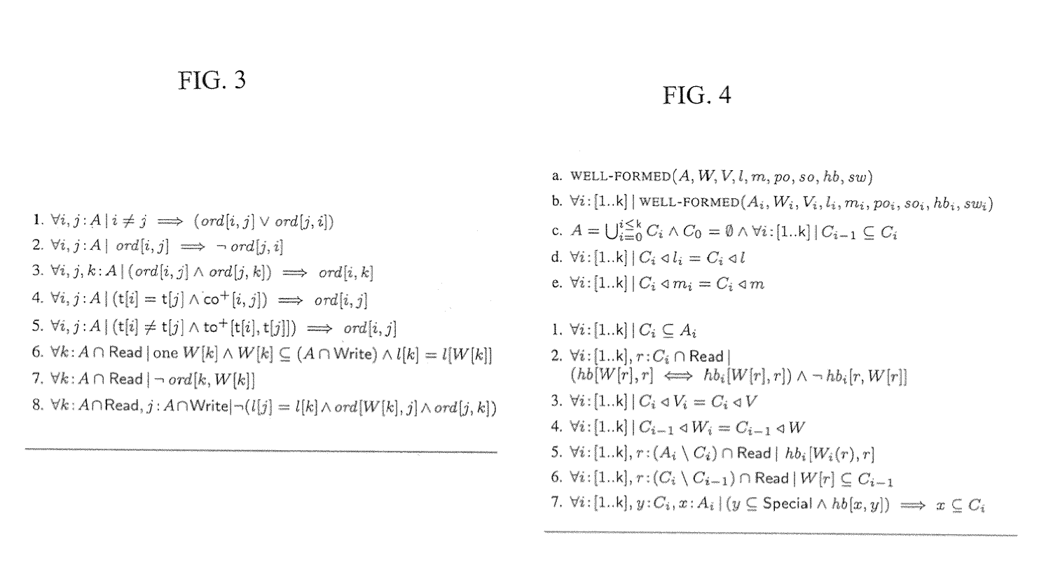

Example: Sequential Consistency: Sequential consistency (SC) is an easily understood memory model that simply needs that all executed actions appear in a (weak) total order that is consistent with the program order. FIG. 3 shows a relational specification of sequential consistency without synchronization, as formalized by Yang et al. (“Nemos: a framework for axiomatic and executable specifications of memory consistency models”, in IPDPS '04, pages 26-30, 2004). Constants are displayed in the sans-serif font, logic keywords in the roman font, and variables in italics. The expression r[x], where r is a binary relation and x is a scalar (or, in relational logic, a singleton unary relation), denotes the relational image of x under r; r[x, y] denotes a formula that evaluates to true only if the relation r maps x to y; and r⁺ denotes the transitive closure of r. The operator “one” constrains its argument relation to contain exactly one tuple.

We define sequential consistency in terms of the execution structure E=(|A, W, V, l, m, ord|) and program constants co, to, t, Read and Write. The variable ord models the ordering of the executed actions A; the constant t maps each action in a program to the thread that executes it; the constant “to” denotes the partial execution order among threads; and Read and Write model all actions in a program whose action kind is a read or a write, respectively. The first three formulas in FIG. 3 constrain ord to be weakly total, asymmetric and transitive. The fourth and fifth formulas specify that it is consistent with the program order and the thread execution order. The sixth formula constrains W to be a function from executed reads to executed writes and to be consistent with the location-accessed relation. The seventh and eight formulas require that W be consistent with ord: a read k cannot see a write that follows it in the aid relation, and no write to l[k] is ordered (by ord) between W[k] and k.

Example: Java Memory Model: The Java Memory Model (JMM) specifies what behavior is legal for a given program using a “committing semantics”. An execution is legal if it can be derived from a series of speculative executions of the program, constructed according to the following rules. The first execution in the series is “well-behaved”: its reads can only see writes that happen-before them. The happens-before ordering (hb) transitively relates reads and writes in an execution according to the program order (pa) and the synchronizes-with (sw) order implied by synchronization constructs. The remaining executions in the series are derived from the initial well-behaved execution by “committing” and executing data races. After each execution, one or more data races from that execution are chosen, and the reads and writes involved in those data races are remembered, or “committed”. The committed data races are then executed in the next execution: each read in the execution must either be committed and see a committed write through a race, or it must see a write through the happens-before relation. The committed writes are also executed, and they write the committed values. Any execution reachable through this process is legal under the JMM.

FIG. 4 presents a relational formalization of the revised JMM. A JMM execution E=(|Aᵢ, Wᵢ, Vᵢ, mᵢ, poᵢ, soᵢ, hbᵢ, swᵢ|) includes four ordering relations: po, so, hb, sw. The relation po models the program order, which is total over the actions of a single thread and which does not relate actions from different threads; so is a total order over all synchronization actions in A (i.e., the lock, unlock, thread start and thread end actions); sw consists of the tuples (a, b) in so such that a is an unlock and b is a lock on a given monitor, or a is a write and b is a read of a given volatile location in shared memory; and hb is the transitive closure of po∪sw. An execution is well-formed, denoted by WELL-FORMED(E), if its constituent relations satisfy Definition 7 of the revised JMM, which we omit here for brevity. A well-formed execution E is legal if there is a finite sequence of sets Cᵢ, where 0≦i≦k, and a finite sequence of well-formed executions Eᵢ=(|Aᵢ, Wᵢ, Vᵢ, lᵢ, mᵢ, poᵢ, soᵢ, hbᵢ, swᵢ|) that satisfy the constraints in FIG. 4. The upper bound on the number of speculative executions, denoted by k, can either be provided as an input to the tool 10 or the tool 10 will compute a sound k from the program text. The symbol [symbol] in FIG. 4 denotes domain restriction, and all other symbols have their previously defined or standard meaning.

Proof of legality (witness): Given a test program P and a memory model M, the tool 10 generates a legality formula F(P, M) of the form F(P,E)̂Fₐ(P,E)̂ [symbol] ᵢ₌₁^{i<k} F(P,Eᵢ) ̂Mₚ(E, Eₗ, . . . , Eₖ), where k≧0; F(P,E) is true only if the execution E respects the intra-thread semantics of P; Fa(P, E) is true only if E satisfies all of the assertions in P; and Mₚ(E, Eₗ, . . . , Eₖ) is true only if the constraints that constitute Mare satisfied with respect to the constants that describe P and the variables that define E, Eₗ, . . . , Eₖ. For memory models that are not specified in terms of speculative executions, F(P, M) simplifies to F(P,E) ̂Fₐ(P,E) ̂Mₚ(E).

A model of the formula F(P, M) is an assignment of relational values (i.e. sets of tuples) to the variables in E, Eₗ, . . . , Eₖ which makes each constraint in the formula true. This assignment, if it exists, is a concrete witness that at least one execution of P is both legal with respect to M and satisfies all the assertions in P. The tuples that comprise a model for tool 10 are drawn from a finite set, or universe, of symbolic values computed by the tool based on the program text and the values of the finitization parameters. The universe for a program P consists of six kinds of symbolic values: 1) heap objects (Note that the heap for a finitized test program P is necessarily finite: a sound upper bound on its size can be computed simply by counting the object allocation (i.e. new) statements in P.) that may be allocated by P; 2) the locations (fields) referenced within P; 3) memory actions that may be performed by P; 4) the threads that comprise P; 5) the bit values used for representing integers; and 6) the boolean values true and false.

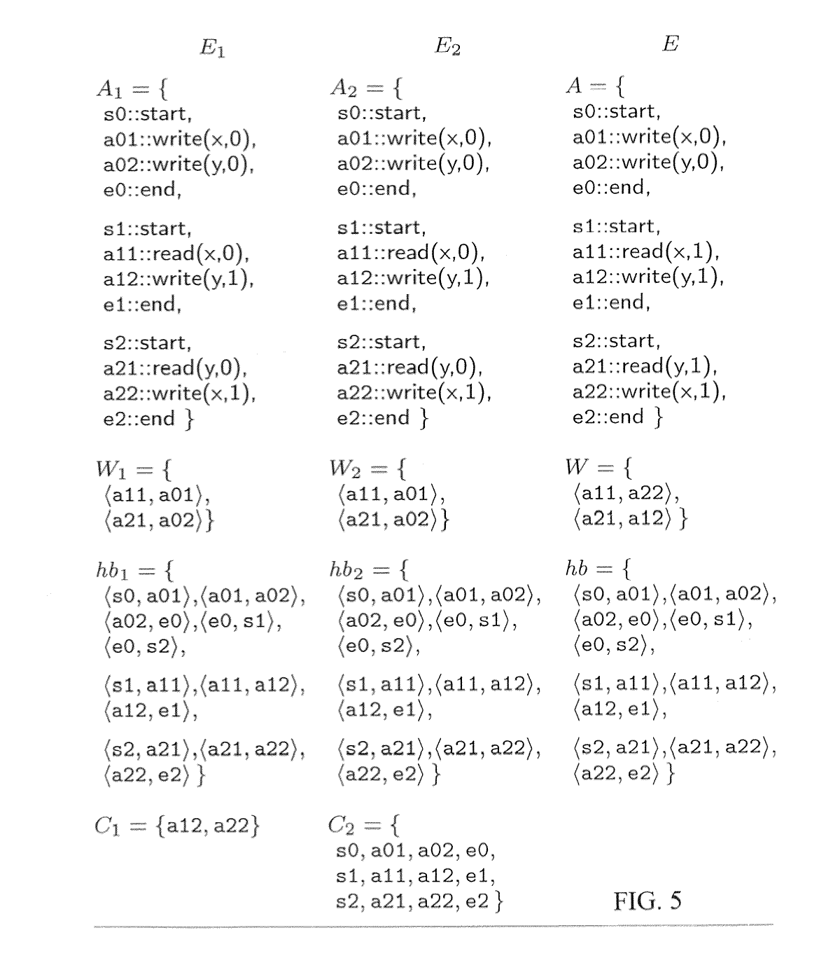

Referring to FIG. 5, a witness that demonstrates the legality of the program in FIG. 2 with respect to the revised DAM (FIG. 4) is illustratively shown. For readability, tool 10 (FIG. 1) displays formatted snippets of the model 12 produced by the constraint solver 22 rather than the complete assignment from variables to values. As before, the symbolic value aij represents the action generated by the j^{th} instruction of the i^{th} thread, and si and ei represent the start and end actions of the i^{th} thread. Each action in the set A (or Aᵢ) of executed actions is annotated with its action kind. Read and write actions are additionally annotated with the location they access and the value they read or write. For example, the annotation “::read(x,0)” on the action all in the set A₁ means that a11 was a read of the value 0 from the field x (i.e. V₁[W₁[a11]]=0 and l₁[a11]=x). The values assigned to orderings such as hb are shown partially; we only display the tuples in their transitive reduction in FIG. 5.

Operationally, the execution E in FIG. 5 is justified as follows. We start with the well-behaved execution Eₗ, in which each read sees the write that happens before it. In particular, both the read of x by the thread t1 and the read of y by t2 see the initial writes of 0 to these locations. The execution E, has two data races: the actions a11 and a22 form a data race on x, and the actions a12 and a21 form a data race on y. We can now commit the write from either data race or from both. Tool 10 chooses to commit both, setting C₁ to {a12, a22}. The next execution, E₂, then performs the committed writes. Note that a12, a22 ε A₂, and each writes 1 to its respective location. The reads of E₂ once again see the default writes since no reads have been committed to C₁. In the second step, we commit the reads and all the other actions to C₂. The final execution, E, performs the actions from C₂, with each committed read seeing the write of 1 in the opposite thread through a data race.

Proof of illegality (minimal core): A formula that has no models is said to be unsatisfiable. Unsatisfiability of a formula F(P, M) for tool 10 means that the (finitized) program P has no executions that are legal with respect to M and that also satisfy all the assertions in P. If the user of the tool 10 expects P to be legal with respect to M, a lack of witnesses indicates a bug either in the specification of M or in the encoding of P or in the setting of the finitization parameters. But even if P is expected to be illegal, the unsatisfiability of F(P, M) alone is not a sufficient indicator that M and P are free of bugs. The formula may be trivially unsatisfiable, for example, because M is overconstrained, admitting no executions of any P.

To aid in the understanding of causes of illegality, the tool 10 outputs a minimal unsatisfiable core for each unsatisfiable formula F(P, M). An unsatisfiable core is a subset of the formula's constraints that is itself unsatisfiable. Every such subset includes one or more critical constraints that cannot be removed without making the remainder of the core satisfiable. Non-critical constraints, if any, are irrelevant to unsatisfiability and generally decrease a core's diagnostic utility. Cores that include only critical constraints are said to be at minimal.

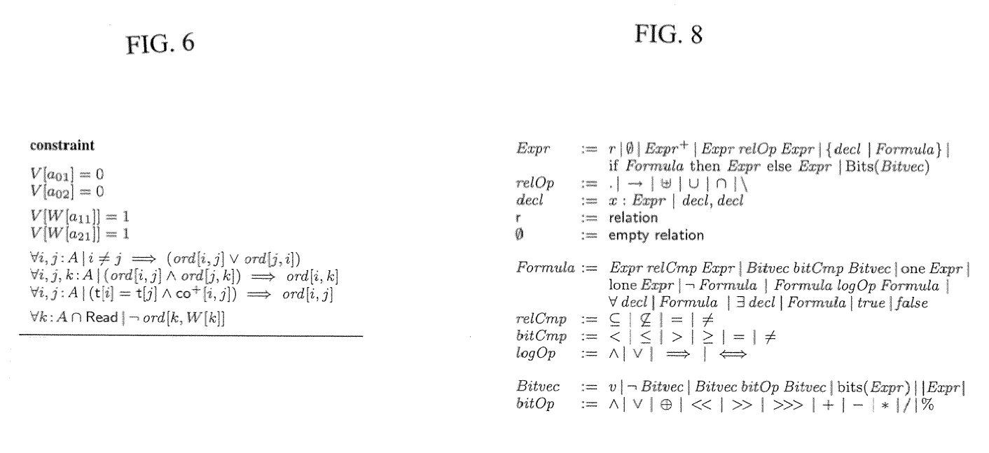

An example of a minimal core produced by the tool 10 in accordance with the present principles is illustratively shown in FIG. 6. The core consists of six constraints drawn from F(P, M)=F(P,E)̂Fa(P,E) ̂Mₚ(E), where P is the program in FIG. 2 and M is sequential consistency. Note that the tool 10 encodes F(P, E) and Fa(P, E) in terms or the variables aij each of which is constrained to evaluate to the action (if any) generated by E while executing the j^{th} instruction of the i^{th} thread. The first two constraints in FIG. 6 are drawn from F(P, E) and encode the meaning of the instructions on lines 2 and 3 of FIG. 2B. The next two constraints come from Fa (P, E) and encode the assertions on lines 8 and 14. The remaining constraints are drawn from the Mₚ(E) definition in FIG. 3, lines 1, 3, 4, and 7, respectively.

We expect all sequentially consistent executions of the test program 16 in FIG. 1 and FIG. 2 to end with assertion failures because all interleavings of the program's instructions result in at least one of the reads seeing the value zero. To get legal (i.e. non-failing) SC executions, we would have to modify P as shown in FIG. 2B, as follows: either change the value written by an initial write to 1 (lines 2-3); or have an assertion expect a read of 0 (lines 8-14); or swap the read and the write instructions in one of the user threads (lines 6-7, 12-16). The core in FIG. 6 reflects this, confirming that both the memory model and the program behave as intended. According to the core, F(P, M) is unsatisfiable because all initial writes write 0; all assertions expect 1; all actions need to be executed in a total order consistent with co (which, in this case, means that at least one of the reads must occur before the non-initial write to the same location); and no read can observe an out-of-order write.

Referring to FIG. 7, an illustrative system embodiment of tool 10 is shown in accordance with one embodiment. Analysis of a test program P and a memory model M involves staged application of the following modules. A processor 202 or group of processors is configured to preprocess the program P. Processor 202 works in conjunction with memory 210 to finitize P and convert it into an intermediate form I(P). A translator 204, which may be stored in memory 210 and may be implemented using the same or a different processor. Translator 204 transforms I(P) into a relational representation R(P). A constraint assembler 206, which may be stored in memory 210 and may be implemented using the same or a different processor, combines R(P) and M to produce a legality formula F(P, M). A bounds assembler 208, which may be stored in memory 210 and may be implemented using the same or a different processor, computes a set of bounds B(P, M) on the space to be searched for a model or a core of the legality formula F(P, M). A constraint solver 212, which may be stored in memory 210 and may be implemented using the same or a different processor, either solves the relational satisfiability problem defined by F(P, M) and B(P, M) or produces a minimal core showing why a solution could not be found.

The translator 204, constraint assembler 206, and bounds assembler 208 are provided in accordance with the present principles. Preprocessing and solving may utilize known modules for program analysis libraries and constraint solvers.

The present approach uses of relational logic, which extends first-order logic with relational algebra and signed bitvector arithmetic. This logic is a relation: a set of tuples of equal length, drawn from a common universe of atoms. Atoms can denote integers or uninterpreted symbolic values. The arity of a relation, which can be any positive integer, determines the length of its tuples. We refer to unary relations (i.e. relations of arity 1) as “sets” and to singleton unary relations as “scalars.”

The kernel of the logic, illustratively shown in FIG. 8, includes standard bitvector operators; connectives and quantifiers of first order logic; and the operators of relational algebra. The latter include relational join (.), product (→), override [symbol] union (∪), intersection (∩), difference (\), and transitive closure (⁺). The join of two relations is the pairwise join of their tuples, where [symbol] aₒ, . . . , aₖ [symbol] . [symbol] aₖ, . . . , aₙ [symbol] yields [symbol] (aₒ, . . . , aₖ₋₁, aₖ₊₁, . . . , aₙ [symbol] . We use e, r and r[e] interchangeably to represent the join of e and r. The product of two relations is the pairwise product of their tuples, which is defined as [symbol] aₒ, . . . , aₖ [symbol] → [symbol] aₘ, . . . , aₙ [symbol] = [symbol] aₒ, . . . , aₖ, aₘ, . . . , aₙ [symbol] . The override expression r [symbol] { [symbol] a, bₗ, . . . , bₙ [symbol] } produces a variant of r in which all tuples that start with a are replaced with [symbol] a, bₗ, . . . , bₙ [symbol] . The formulas lone Expr and one Expr are true for relations with at most one and exactly one tuple, respectively. The cardinality expression |r| gives the number of tuples in r as a bitvector; bits (r) computes the sum of atoms representing integers in the set r as a bitvector; and Bits(v), where v is the bitvector bₒ . . . bₖ evaluates to the set of integer atoms 2ⁱ for which bᵢ≠0. All other expressions and formulas have their standard meaning.

Preprocessing (202): To translate a test program P to relational logic, tool 10 first, finitizes P's code by unwinding all loops and inlining all method calls. The finitized code is then transformed into an intermediate form that captures its data, control and synchronization dependencies. The intermediate form of P is the structure I(P)=(|efg, guard, pointsTo, maySee|), in which efg denotes the extended control flow graph of P; guard maps each instruction in efg to the control conditions that guard its execution; pointsTo maps each variable to the heap objects, if any, that it may point to at runtime; and maySee maps each read in efg to the set of writes that it may observe. All four components of I(P) are computed using standard analyses (using e.g., WALA tools).

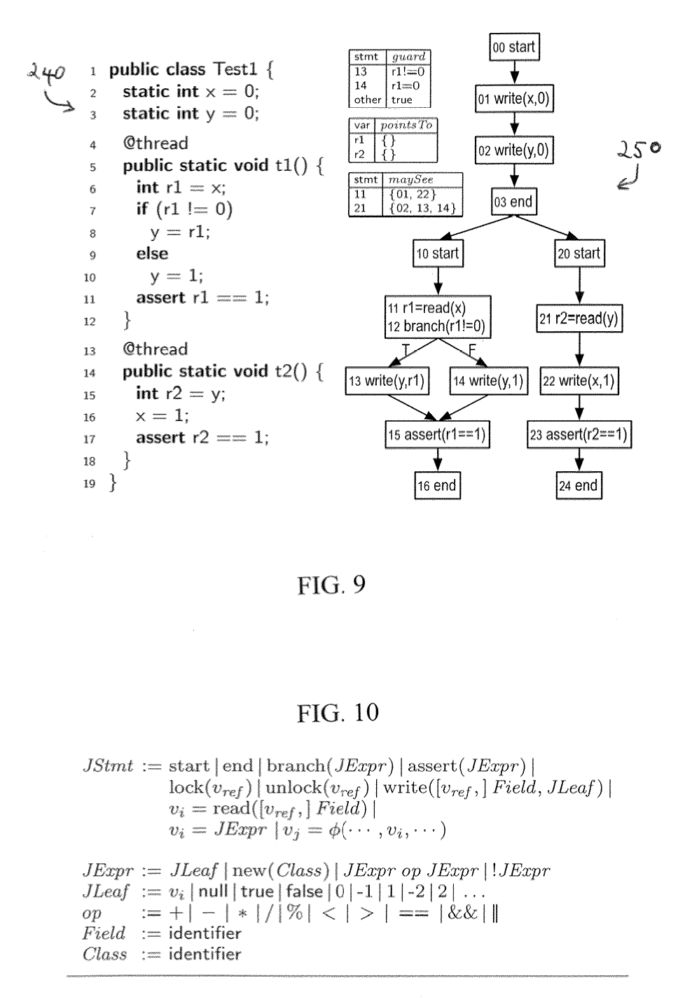

An example of I(P) is shown in FIG. 9, which shows an annotated Java encoding 240 and an extended control flow graph 250 of P in intermediate form. The extended control flow graph 250 of P is the union of the control flow graphs of P's threads, with additional edges between the exit and entry block's of threads whose execution is partially ordered. The nodes of the graph 250 are comprised of WALA statements reproduced in FIG. 10 in the Static Single Assignment (SSA) form, which gives a new name to every new definition of a variable. Variable definitions are merged using φ statements, and heap accesses are expressed as explicit read and write statements. The name v_{ref} denotes a pointer variable. The synthetic start and end statements indicate the start and end of a thread. We define the function guard to operate over WALA statements as follows. The value of guard(s, vᵢ), where s is vⱼ=φ ( . . . , vᵢ, . . . ), is the condition under which s assigns vᵢ to vⱼ.

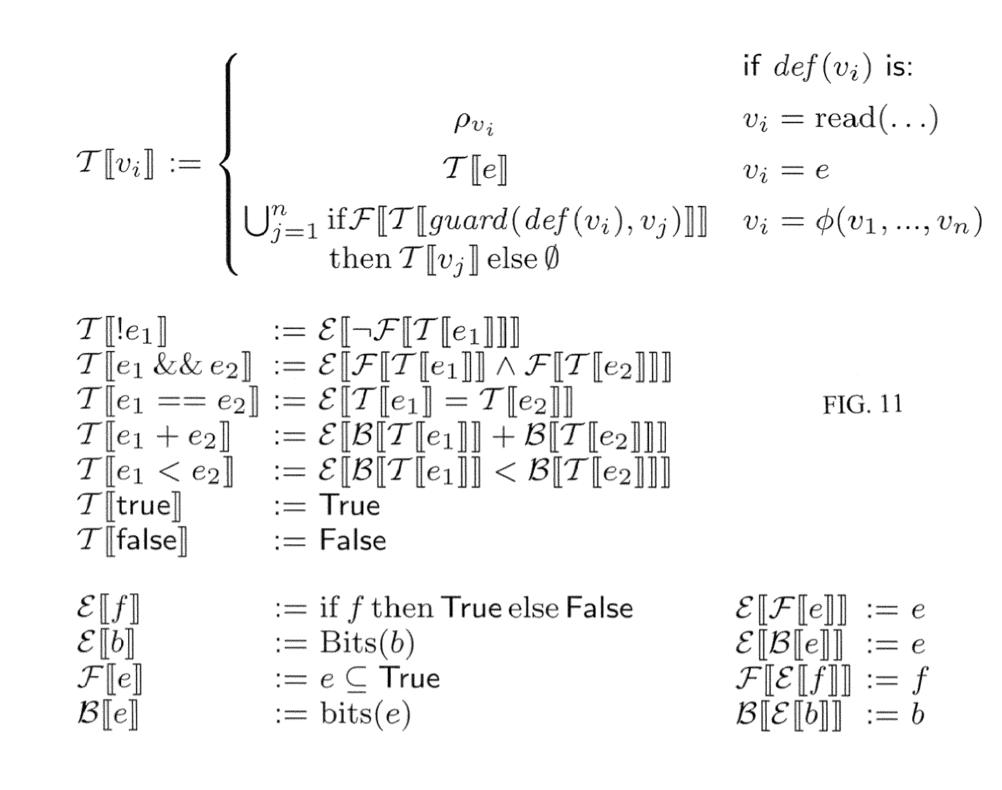

Translation (204): The translation of a preprocessed program I(P) to its relational representation R(P) relies on a translation function T: JExper→Expr (FIG. 11) that takes a WALA expression and returns a relational expression. Unlike relational encodings for sequential programs, the function T does not interpret heap accesses. That is, if a variable vᵢ is defined by a read statement s,T[[vᵢ]] is an unconstrained unary relation pᵥᵢ, which acts as a placeholder for the value read by s. In a sequential setting, a relational encoding for the value seen by a read can be computed directly from the program text. In a concurrent setting, however, these values are determined both by the program semantics and by the memory model. The placeholders are a feature of our framework that allows us to separate the encoding of program semantics from the specification of the memory model: T encodes the program semantics in terms of the placeholders, which the constraint assembler then replaces with relational expressions dictated by the memory model.

For expressions that are not defined by heap reads, the function T yields the same relational expressions as prior encodings for sequential programs. FIG. 11 reproduces a representative sampling of those. The function def takes a variable in SSA form and returns the statement that defines its value. True and False are constant unary relations whose values are the atoms true and false, respectively. The function ε converts formulas and bitvectors to expressions, and F and B do the reverse. All integer and boolean operations are translated using their corresponding operators in relational logic.

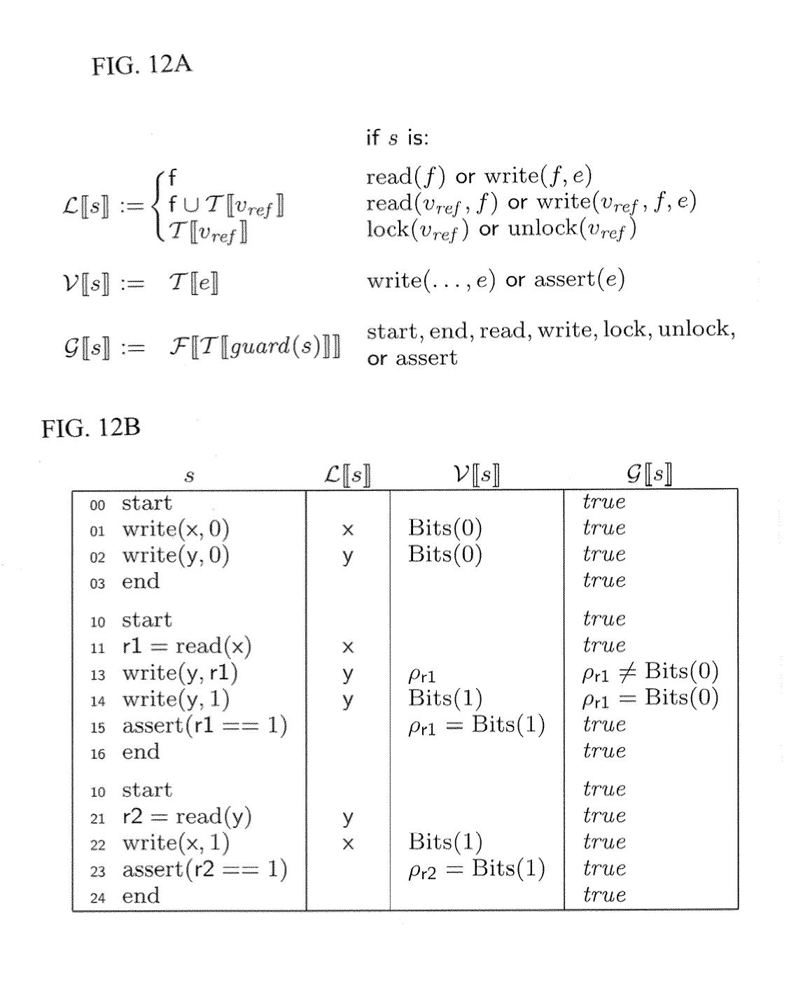

The relational representation R(P) is a stricture (|I(P), L, V, G|), which captures the semantics of the program I(P) with the partial functions L, V and G (FIG. 12A). The function L maps reads, writes, locks and unlocks to relational expressions that represent the heap locations or monitors accessed by these statements.

Ifs is a read or a write of a static field f, L[[s]] yields the constant relation f whose value, { [symbol] f [symbol] }, consists of the atom that represents the field f. If s reads or writes an instance field f, L[[s]] yields f∪T└└v_{ref}┘┘, whose value is a set of two unary tuples, one of which represents the field f and the other the object referenced by v_{ref}. For monitor statements, L[[s]] produces an expression that evaluates to the object that is locked or unlocked by s. The function V maps writes and assertions to relational encodings of the values that they write or assert. The function G takes each statement s in its domain to a relational formula that represents the guard of s. FIG. 12B shows an example of R(P) for the program in FIG. 9.

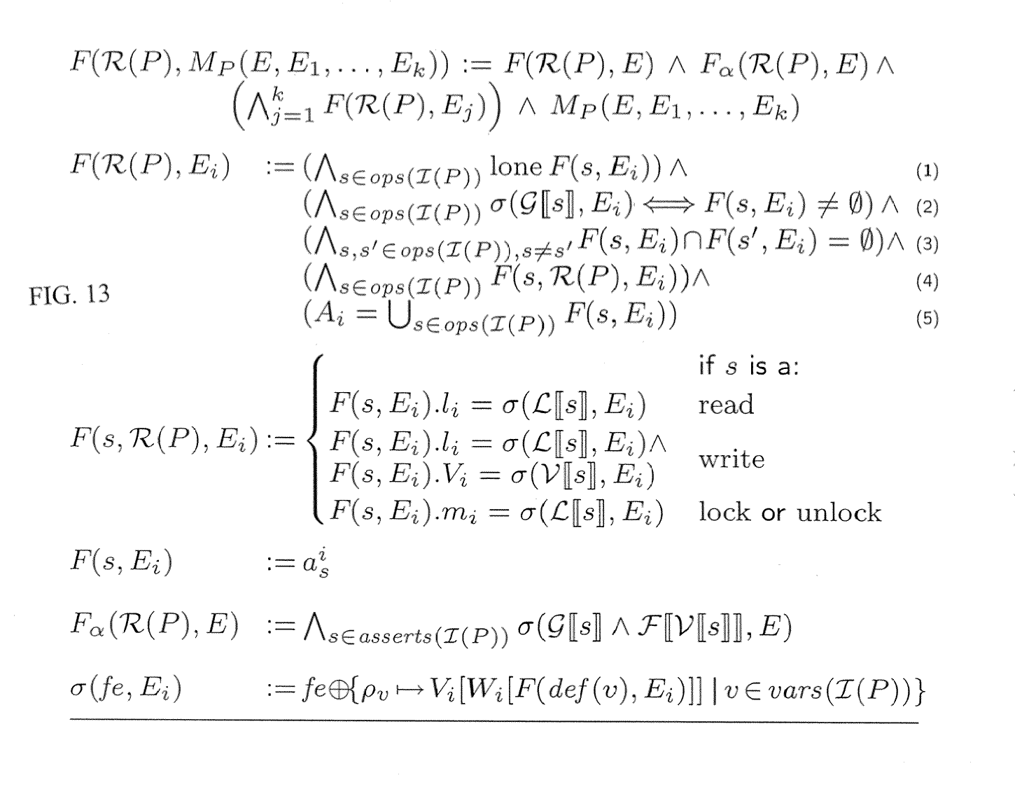

Constraint assembly (206): Tool 10 encodes the legality of a program R(P) with respect to a memory model M_{P}(E, Eₗ, . . . , Eₖ) using the recursive constraint assembly procedure defined in FIG. 13. The constraint assembly function F includes the auxiliary function ops which yields all statements in a program i(P) that perform memory related operations. The function asserts returns all assertion statements in a given program; vars returns all variables defined by the program's statements. The operator performs syntactic substitution e.g., fe⊕{x [symbol] y} replaces all free occurrences of x in the formula or expression fe with y.

The procedure F takes as input a relational representation R(P) and a memory model specification M_{P}(E, Eₗ, . . . , Eₖ) and produces the legality formula F(P, M). The base step, F(s, Eᵢ), allocates a fresh unary relation aₛⁱ for each statement s and execution Eᵢε{E, Eₗ, . . . , Eₖ} to represent the action that Eᵢ performs if it executes s. The function σ(fe, Eᵢ) replaces all placeholder relations pᵥ in the formula or expression fe with Vᵢ[Wᵢ[F(def (v),Eᵢ]], which is the value observed by the read that defines the variable v in the context of Eᵢ. In other words, the application of σ supplants the placeholders generated in the translation stage with the values specified by the memory model.

The recursive step F(R(P),Eᵢ) constrains the execution Eᵢ to respect the semantics of R(P) by generating the following formulae: (1) a statement executed by Eᵢ can perform at most one action; (2) a statement performs an action if and only if its guard is true in the context of Eᵢ; (3) different statements, if executed, must perform different actions; (4) the value-written (Vᵢ), location-accessed (lᵢ) and monitor-used (mᵢ) relations of Eᵢ are consistent with the corresponding values given by V and L; and (5) the set of all actions executed by Eᵢ (denoted by Aᵢ) is the union of the actions performed by the executed statements. The recursive step F(s, R(P), Eᵢ) constrains the relations that define the execution of the statements to conform to the program semantics. The step Fa is applied only to the main execution E, constraining it to satisfy all assertions in P.

Bounds assembly and solving (208): The last phase of the analysis-finding a model or a core of the assembled legality formula-is delegated to a Kodkod constraint solver. Kodkod takes as input a relational satisfiability problem, which is solved by reduction to boolean satisfiability and application of a SAT solver to the resulting boolean constraints. A relational satisfiability problem consists of a formula in relational logic, a universe of atoms in which the formula is to be interpreted, and a lower and upper bound on the value of each relation in the formula. These bounds are given as sets of tuples drawn from the provided universe. The upper bound Bᵤ(r) specifies the tuples that the relation r may contain in a model of the formula. The lower bound Bₗ(r)⊂Bᵤ(r) designates the tuples that r must contain, if any. Relations with the same lower and upper bound, such as the relation co (described above), are said to be constant. Relations with different lower and upper bounds are called variables. The total number of variable tuples—i.e. Σᵣ|Bᵤ(r)\Bₗ(r)|—determines the exponent in the size of the search space explored by Kodkod. Minimizing Bᵤ(r) and maximizing Bₗ(r) is therefore needed for performance. An algorithm for setting the bounds judiciously will be presented, so that the resulting search space is both compact and includes all potential witnesses.

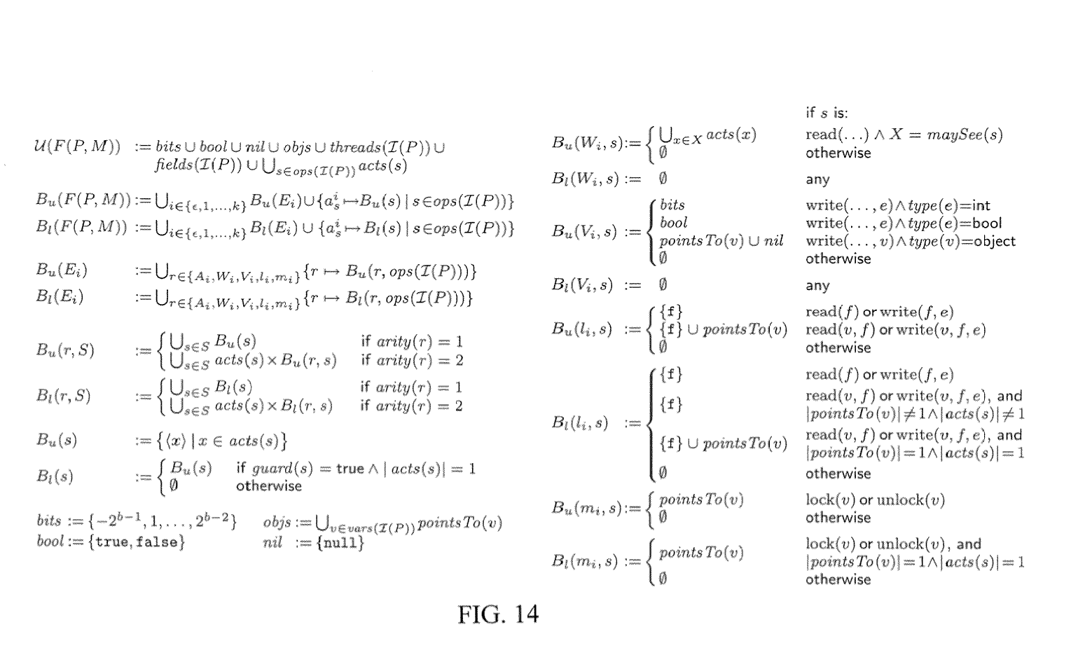

FIG. 14 shows illustrative functions of tool 10 for computing the universe and bounds that, together with the legality formula F(R(P),Mₚ(E, Eₗ, . . . , Eₖ)) comprise a relational satisfiability problem. To simplify the exposition, we only show the derivation of hounds for the relations aₛⁱ that are generated by the assembler and the basic relations (Aᵢ, Wᵢ, Vᵢ, lᵢ, mᵢ) that define an execution Eᵢ. Both the universe and bounds are defined in terms of the auxiliary function acts (discussed below), which maps each statement memory related operation sεops(I(P)) to a set of atoms representing the actions that the execution of a may generate. The upper bound on aₛⁱ is the set of all unary tuples drawn from acts(s). Its lower bound is empty, unless the guard of s is the constant true and acts(s) has exactly one action atom. In this case, the lower and upper bounds on aₛⁱ are the same; i.e., every Eᵢ is guaranteed to execute s and, therefore, to perform the action acts(s). The upper bound on mᵢ maps the action atoms corresponding to a monitor statement s to the object atoms that may be locked or unlocked when s is executed. The lower bound on mᵢ has a mapping for acts(s) only if the object locked or unlocked when executing s is statically known; that is, |pointsTo(v)|=1, where v is a reference to the monitored object. Other bounds are derived from acts and I(P) in a similar fashion.

In FIG. 14, the universe (U) and bounds (Bₗ, Bᵤ) for the legality formula F(P,M) are computed. The auxiliary function threads returns a set of objects that represent the threads in a given program; fields yields the set of fields that are referenced in the program's read and write statements; and acts maps each memory-related statement s in a program to a set of actions (represented symbolically) that may be performed when s is executed. ε stands for the empty string and b is an integer finitization parameter provided by the user.

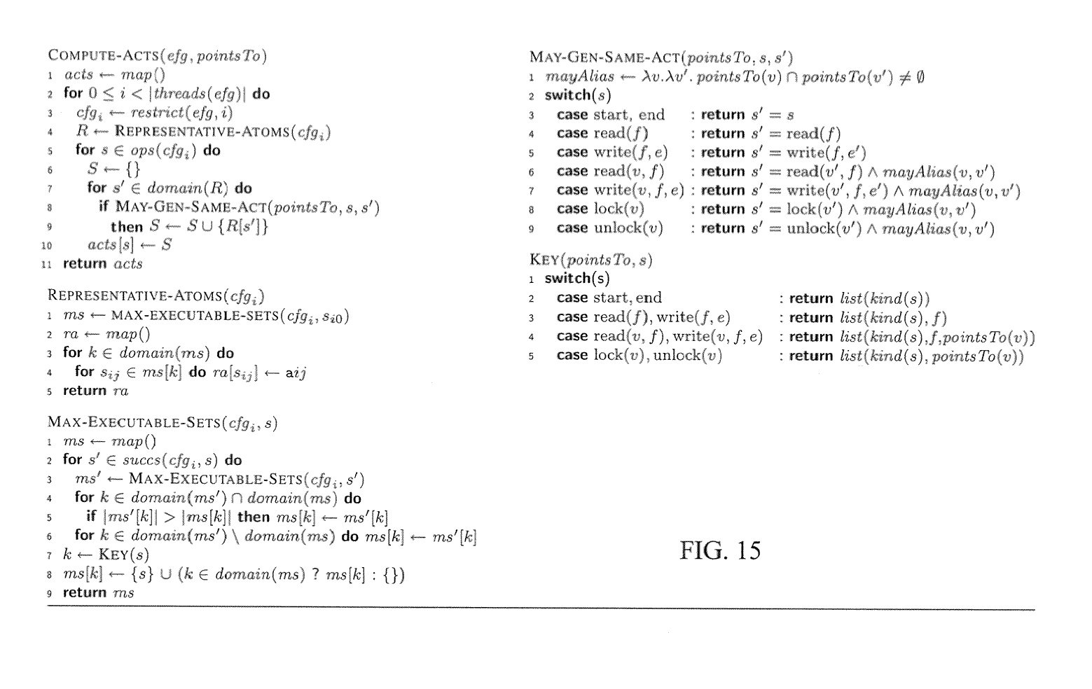

The procedure COMPUTE-ACTS for computing the acts function is presented in FIG. 15. The auxiliary function restrict(cfg, i) restricts a given cfg to the control graph of the i^{th} thread; domain(m) yields the set of all keys mapped by the map m; dominates(cfg, s, s′) (or postdominates(cfg, s, s′)) is true only if s dominates (or postdominates) s′ in cfg; and kind(s) returns the kind statement s as a string (e.g., “read”, “write”, etc.). COMPUTE-ACTS works thread by thread as follows. Given a thread tᵢ, we use the function KEY to partition the statements of tᵢ into equivalence classes. For example, two reads of the same static field have equal keys and are in the same equivalence class. Then, for each class of statements C, MAX-EXECUTABLE-SETS finds the largest subset Cₘₐₓ⊂C such that all elements of Cₘₐₓ appear on a single path through the CFG (control flow graph) of tᵢ. We say that the statements in Cₘₐₓ are representative of C. Following the generation of Cₘₐₓ for each C, REPRESENTATIVE-ATOMS creates a unique atom aij for every representative statement sij and records the correspondence between the two in a map. The size of this map is an upper bound on the number of actions that any execution of tᵢ may generate, and it is bounded above by the total number of memory-related statements in tᵢ. The last few lines of COMPUTE-ACTS use the representatives map to compute acts(s) for all s in tᵢ. In particular, acts(s) contains the atom aij if s is the representative statement sij or if s and sij may generate the same memory event (e.g., a read of the field f) and neither statement (post)dominates the other in the CFG of tᵢ.

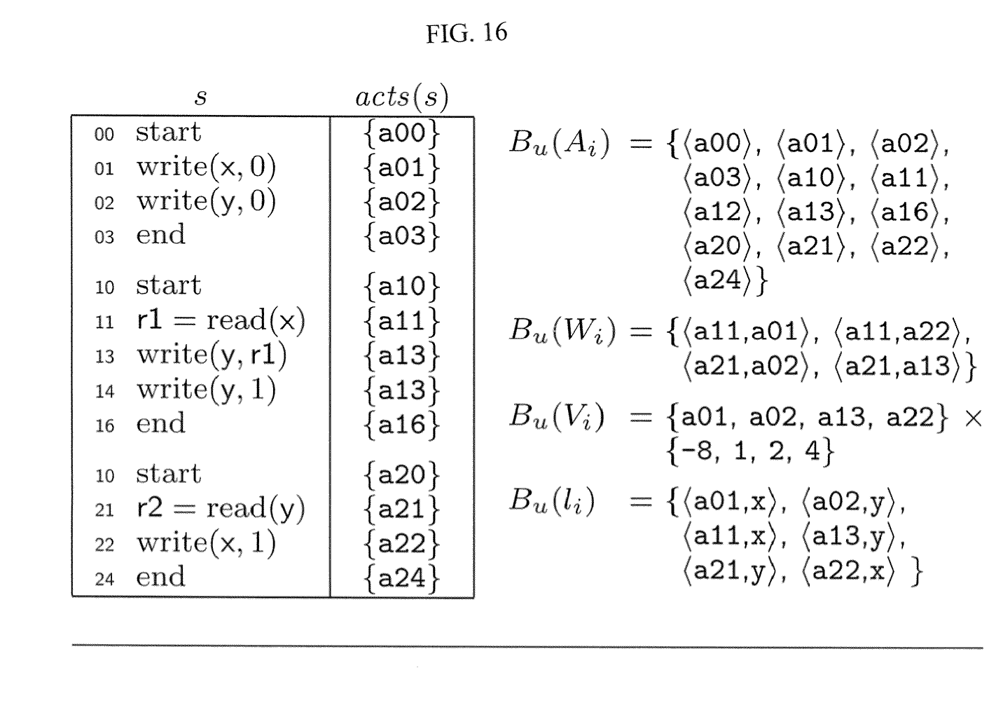

An example of the acts mapping and of the resulting bounds is shown in FIG. 16. The sample mapping illustrates three notable properties of acts, which ensure that our bounds are both compact and do not exclude any witnesses:

1. each statement s is mapped to at least one atom;

2. if s and s′ may both be performed in some execution, the union of their acts sets contains at least two atoms;

3. if s and s′ are in different branches of a thread but may generate the same memory event, the intersection of their acts contains at least one atom; and

4. if the execution of s implies that of s′, the intersection of their acts sets is empty.

The first two properties (1. and 2.) ensure that witnesses are not missed because the search space excludes executions that perform certain statements or certain combinations of statements. For example, if acts(s) is empty for some s, then both the lower and the upper bound on the relation aₛⁱ are also empty, which forces the solver to treat aₛⁱ as the constant relation . As a result, the only way to satisfy the legality constraint σ(G[[s]], Eᵢ) [symbol] F(s, Eᵢ)≠ is to have the guard of s evaluate to false. An empty acts set for s therefore rules out all witnesses that perform s. Similarly, if acts(s) ∪ acts(s′) contains just one atom aij, then Bᵤ(aₛⁱ)=Bᵤ(aₛ^{t})={ [symbol] aij [symbol] }. In this case, the only way to satisfy the legality constraint F(s, Eᵢ)∩ F(s′, Eᵢ)= is to set either aₛⁱ, or a_{s′}ⁱ, (or both) to the empty set, thus ruling out all witnesses that execute both s and s′.

The third property (3.) ensures that witnesses are not missed because the memory model equates actions performed by different statements in the context of different executions. For example, the program in FIG. 9 is legal under the Java Memory Model. In its witness execution E, statement 11 of FIG. 9 reads the value 1 from x, which causes statement 13 to execute and write the value 1 to y; i.e. a₁₃⊂ A. The execution E is justified by a speculative execution E₁, in which statement 11 reads the value 0 from x, causing statement 14 to execute and write the value 1 to y; i.e. a₁₄¹ ⊂ A₁. As a result, the only way to speculatively commit a write of 1 to y is to commit the result of executing a₁₄¹, but the only way to honor this commitment in E is by executing a₁₃. Hence, we must have a₁₃=a₁₄¹, which means that Bᵤ(a₁₃)∩Bᵤ(a₁₄¹) (and, by extension, acts(s₁₃)∩acts(s₁₄)) must be non-empty.

The fourth property (4.) ensures compactness of the search space. Namely, if the execution of s implies that of s′ (i.e. s postdominates s′ or s′ dominates s), it is not necessary for acts(s) and acts(s) to intersect. We can therefore leave acts(s) ∩ acts(s) empty to get a smaller search space without losing any witnesses. To see that no witnesses are lost, consider two assignments acts and acts_{ø} which are the same except that acts(s) ∩ acts(s′)≠ and acts_{ø} (s) ∩ acts_{ø} (s′)=. For every execution Eᵢ allowed by acts, there is an equivalent Eᵢ^{ø} allowed by acts_{ø}. First, suppose that Eᵢ executes s. Because s [symbol] s′, Eᵢ must also execute s′. Hence, aₛⁱ∩a_{s′}ⁱ=ø, which can be satisfied by bounds based on acts_{ø}. That is, Eᵢ^{ø}=Eᵢ. Now, suppose that Eᵢ that executes only s′. Once again, aₛⁱ∩a_{s′}ⁱ=ø and Eᵢ^{ø}=Eᵢ. This shows that acts_{ø} will never eliminate a witness that involves a single execution. A similar argument can be applied to witnesses involving multiple executions.

In accordance with the present principles, a fully automated tool (10) enables debugging and reasoning about axiomatic specifications of memory models. The tool 10 was used to check the JMM, a revised version of JMM, and several well-known hardware-level memory models. These experiments confirmed previously known discrepancies in the expected behavior of test programs, and uncovered new ones. The tool 10 is fully automated and can handle the current axiomatic specification of the JMM.

Having described preferred embodiments for a system and method for debugging memory consistency models (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Flaying thus described aspects of the invention, with the details and particularity required by the patent laws, what is claimed and desired protected by Letters Patent is set forth in the appended claims.

What is claimed is:

1. A method for analyzing a test program with respect to a memory model, comprising:
preprocessing a test program into an intermediate form using a processor;
translating the intermediate form of the test program into a relational logic representation;
combining the relational logic representation with a memory model to produce a legality formula;
computing a set of bounds on a space to be searched for the memory model or a core of the legality formula; and
solving a relational satisfiability problem defined by the legality formula and the set of bounds to at least one of determine a legal trace of the test program and debug the memory model.

2. The method as recited in claim 1, wherein if no solution exists during the solving step, producing a minimal core showing why a solution could not be found.

3. The method as recited in claim 1, wherein preprocessing a test program includes finitizing the test program.

4. The method as recited in claim 1, wherein the intermediate form includes an expression of one or more of an extended flow graph of the test program, mappings of instructions to control conditions, mappings of variables to heap objects and mappings of read statements to write statements that are observed.

5. The method as recited in claim 1, wherein combining includes replacing placeholder parameters generated during translating with values stored by the memory model to constrain execution of the relational logic to semantics defined by the test program.

6. The method as recited in claim 1, wherein solving a relational satisfiability problem includes employing a satisfiability solver.

7. A computer readable storage medium comprising a computer readable program for analyzing a test program with respect to a memory model, wherein the computer readable program when executed on a computer causes the computer to perform the steps of:
preprocessing a test program into an intermediate form;
translating the intermediate form of the test program into a relational logic representation;
combining the relational logic representation with a memory model to produce a legality formula;
computing a set of bounds on a space to be searched for the memory model or a core of the legality formula; and
solving a relational satisfiability problem defined by the legality formula and the set of bounds to at least one of determine a legal trace of the test program and debug the memory model.

8. The computer readable storage medium as recited in claim 7, wherein if no solution exists during the solving step, producing a minimal core showing why a solution could not be found.

9. The computer readable storage medium as recited in claim 7, wherein preprocessing a test program includes finitizing the test program.

10. The computer readable storage medium as recited in claim 7, wherein the intermediate form includes an expression of one or more of an extended flow graph of the test program, mappings of instructions to control conditions, mappings of variables to heap objects and mappings of read statements to write statements that are observed.

11. The computer readable storage medium as recited in claim 7, wherein combining includes replacing placeholder parameters generated during translating with values stored by the memory model to constrain execution of the relational logic to semantics defined by the test program.

12. The computer readable storage medium as recited in claim 7, wherein computing a set of bounds includes solving a relational satisfiability problem by reducing to the relational satisfiability problem to a Boolean satisfiability problem.

13. The computer readable storage medium as recited in claim 7, wherein solving a relational satisfiability problem includes employing a satisfiability solver.

14. A system for analyzing a test program with respect to a memory model, comprising:
a processor configured to execute and analyze programs stored in memory, the processor receiving as input a test program, converted to an intermediate form, and a memory model;
a translation module, stored in memory and executed using the processor, configured to translate the intermediate form of the test program into a relational logic representation of the test program using a translation function;
a constraint assembler, stored in memory and executed using the processor, configured to combine the relational logic representation with the memory model to produce a legality formula;
a bound assembler, stored in memory and executed using the processor, configured to compute a set of bounds on a space to be searched for the memory model or a core of the legality formula; and
a solver configured to solve a relational satisfiability problem defined by the legality formula and the set of bounds to at least one of determine a legal trace of the test program and debug the memory model.

15. The system as recited in claim 14, wherein if the solver finds no solution exists, a minimal core is output showing why a solution could not be found.

16. The system as recited in claim 14, wherein the intermediate form includes an expression of one or more of an extended flow graph of the test program, mappings of instructions to control conditions, mappings of variables to heap objects and mappings of read statements to write statements that are observed.

17. The system as recited in claim 14, wherein the constraint assembler replaces placeholder parameters generated during translation with values stored by the memory model to constrain execution of the relational logic to semantics defined by the test program.

18. The system as recited in claim 14, wherein the solver includes a satisfiability (SAT) solver.
